(19) United States
(12) Patent Application Publication
(10) Pub. No.: US 2007/0217362 A1
(43) Pub. Date: Sep. 20, 2007

(54) Amended control for resource allocation in a radio access network

(75) Inventors: Tsuyoshi Kashima, Yokohama (JP); Sigit Puspito Wigati Jarot, Yokohama (JP)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/486,834

(22) Filed: Jul. 14, 2006

(30) Foreign Application Priority Data
Mar. 20, 2006 (EP) 06111410.4

(51) Int. Cl. H04Q 7/00

(52) U.S. Cl. 370/330

(57) ABSTRACT

A method for allocation of multi-carrier transmission resources to terminal devices in a network cell of a radio access network, the transmission resources being dividable into symbol-duration time spans in a time domain and into a plurality of sub-carriers in a frequency domain, comprises allocating to a respective terminal device a group of consecutive symbol-duration time spans in the time domain and at least one respective sub-carrier block in the frequency domain, the at least one respective sub-carrier block being formed by a group of respective consecutive sub-carriers. The allocating comprises allocating a respective sub-carrier block and the group of symbol-duration time spans according to one respective allocation type, which is either a localized or a distributed allocation type, the localized allocation type allocating them to one respective terminal device, and the distributed allocation type allocating them to a respective set of terminal devices.

### CROSS-REFERENCE TO RELATED APPLICATIONS

This application claims priority under 35 USC §119 to European Patent Application No. 06111410.4 filed on Mar. 20, 2006.

### FIELD OF THE INVENTION

The present invention relates to the field of allocation of transmission resources to terminal devices in a network cell of a radio access network. In particular, the invention relates to a method for allocation of multi-carrier transmission resources to terminal devices in a network cell of a radio access network, to an allocation-control device for localized or distributed allocation of multi-carrier transmission resources to terminal devices in a network cell of a radio access network, to network node of a radio-access network, to a network cell of a radio-access network, to a radio access network, to a control signal for localized or distributed allocation of multi-carrier transmission resources, and to a control unit for a terminal device to be operated in a network cell of a radio access network.

### BACKGROUND OF THE INVENTION

In the control of an air interface in Radio Access Networks (RANs), Common Control signalling is a means to announce resource sharing between a plurality of terminal devices, e.g., by an allocation table. An allocation table contains exact descriptions of resource allocations for all active terminal devices in a given cell of the radio access network (RAN) for a defined duration, such as the duration of a frame or for a duration of a set of frames.

An allocation table is transmitted in downlink and indicates which terminal devices receive what kind of data resources in downlink during the frame and which users are allowed to transmit on what kind of data resources in uplink during the respective uplink frame.

An allocation table typically includes allocation identification and transport format indications for all terminals, which will either have downlink or uplink resources allocated during that frame. The allocation table specifically includes allocation identification for the same frame, where it is transmitted itself and describes the allocation of that frame only.

Thus, the allocation table is a critical resource for all communication links of a cell/sector and as a common resource of the cell, its format has to be efficient, reliable and unified.

Known prior art includes allocation tables with pointers to dedicated resources by piggybacked signalling and dedicated headers. An example includes allocation tables which point allocation identification (with Transport Format and resource units) for longer than a single frame period of time, say to any defined set of following frames, for example, current frame +1, current frame +2 up to current frame +N . . . Pointing to a frame other than the current frame may be motivated by looser processing time requirements. However, this implies longer round trip time and is typically not favoured. Defining resource allocation over longer than a single frame period of time may be motivated by the reduction of signalling overhead, where the resources available are scarce anyway, for example, in narrow transmission band.

As the allocation table forms a common channel for all active terminals in the cell, it has to be reliable and decodable by all active terminals in the cell coverage area. This means reliable decoding in all conditions of experienced signal-to-noise ratio (SNR), signal-to-interference ratio (SIR), amount of interference from serving cell-to-other cell interference ratio (G-factor), and dominant interference-to-other interference ratio (DIR), in the expected coverage area.

And even more, for terminals making hard handover, the allocation table of an adjacent cell (handover target cell) on the same carrier frequency has to be decodable already in the coverage area of the serving cell (handover source cell). Thus, the allocation table has to be decodable in carrier-to-interference (C/I) levels down to about −7 dB.

In prior art 2 G/3 G, resource allocation is done by dedicated signalling for dedicated resources. To access a dedicated signalling channel, a common channel may be used prior to the use of the dedicated signalling channel. This will obviously cause some delays. In prior art WLAN, resource allocation is based on carrier sensing of collision and packet scheduling. Protocol headers are thus present in every packet to indicate the receiver, which packets to decode. Decoding of headers of all packets, whether intended to be received or not, consumes power of the terminal receiver.

These prior art means are neither sufficient nor efficient enough for the Long-Term Evolution (LTE) of 3 GPP UTRAN (Third Generation Project Partnership Universal Terrestrial Radio Access Network), which is also referred to as E-UTRAN or, in short E-UTRA (UTRA meaning Universal Terrestrial Radio Access). The system requirements for E-UTRAN are described in 3 GPP TR25.913, which is incorporated herein by reference. E-UTRAN enables a much higher symbol transmission rate than prior art RANs.

E-UTRAN adopts multi-carrier technologies such as OFDMA (Orthogonal Frequency Division Multiple Access), and both localized and distributed resource allocations need to be supported. A localized resource allocation uses consecutive sub-carriers for resource allocation. This way, it is possible to allocate only resources with good channel condition to a terminal device, for instance for exploiting multi-user diversity or frequency-selective diversity. A distributed resource allocation, on the other hand, allocates non-consecutive sub-carriers to a terminal device for exploiting a frequency-averaging diversity.

In the long-term evolution of UTRAN, resource allocation should be able to dynamically change on a sub-frame-by-sub-frame basis. Several proposals regarding this issue have been discussed in recent 3 GPP RAN1 meetings.

According to one proposed solution, a distributed allocation of resources can be distributed over the full system bandwidth with sub-carrier resolution following a pre-determent frequency-hopping pattern. However, this process is complicated for when such distributed resource allocation overlaps a localized resource allocation, the localized allocation of resources is punctured, i. e., interrupted by sub-carriers, which are allocated according to a distributed-allocation type. In addition, the hopping pattern of the distributed-allocation type requires extensive and complicated signalling.

Another proposal concerns the distribution of resources according to a distributed-type allocation over the full system bandwidth with sub-carrier resolution as in the previous proposal, but without using any frequency hopping.

However, in the presents of resources, which are allocated according to a distributed-type allocation, the resources available to localized allocation must be distributed, because it only uses the remaining sub-carriers without using puncturing.

Another proposal suggests a semi-static division of the system bandwidth into two parts, one for localized allocation and one for distributed allocation.

However, in this scheme, a distributed allocation cannot the use the full system bandwidth. Furthermore, the flexibility of the allocation is restricted.

### SUMMARY OF THE INVENTION

It is therefore an object of the present invention to provide an allocation-control device and a method for allocation of multi-carrier transmission resources to terminal devices in a network cell of a radio access network that enables a flexible and dynamical scheduling of localized allocations without using a static or semi-static separation of resources into a localized and a distributed resource-allocation section. This object of the invention also applies to a network node of a radio access network cell, a radio access network cell, and a radio access network.

It is another object of the present invention to provide an allocation-control device and a method for allocation of multi-carrier transmission resources to terminal devices in a network cell of a radio access network that allows to perform distributed allocations, which can be distributed over the complete system bandwidth. This object of the invention also applies to a network node of a radio access network cell, a radio access network cell, and a radio access network.

It is a further object of the present invention to provide a control signal for localized or distributed allocation of multi-carrier transmission resources to terminal devices in a network cell of a radio access network, which generates only a small overhead.

According to a first aspect of the invention, a method for allocation of multi-carrier transmission resources to terminal devices in a network cell of a radio access network, the transmission resources being dividable into symbol-duration time spans in a time domain and into a plurality of sub-carriers in a frequency domain. The method comprises allocating to a respective terminal device a group of consecutive symbol-duration time spans in the time domain and at least one respective sub-carrier block in the frequency domain, the at least one respective sub-carrier block being formed by a group of respective consecutive sub-carriers.

According to the method of the invention, the allocating comprises allocating a respective sub-carrier block and the group of symbol-duration time spans, such as, by way of example, one sub-frame duration, according to one respective allocation type, which is either a localized or a distributed allocation type, the localized allocation type allocating them to one respective terminal device, and the distributed allocation type allocating them to a respective set of terminal devices.

The method of the invention is based on the general concept of dividing the frequency resources during one symbol-duration time span into a plurality of frequency resource blocks, which are sub-carrier blocks. One sub-carrier block is formed by a group of respective consecutive sub-carriers. The subcarrier blocks thus form sub-carrier “chunks”, which partition the frequency spectrum comprised by the multi-carrier transmission resources.

According to the method of the invention each sub-carrier block is subject to either a localized or a distributed allocation type during the group of symbol-duration time spans. Therefore, localized allocation and distributed allocation do not share one sub-carrier block during the group of symbol-duration time spans.

The allocation method of the invention provides a simple allocation scheme that enables a corresponding control signalling with a particularly small over-head. A further advantage of the allocation method of the invention is that the method of the invention allows distributed allocation over the complete band-width or only part of the available bandwidth of the multi-carrier transmission resources. It avoids the use of a predetermined separation of localized and distributed allocations. The only restriction for the allocation method is that a given sub-carrier block can only be allocated according to one allocation type either localized or distributed, during one group of single-duration time spans.

However, this does not significantly reduce the frequency diversity nor the flexibility of the allocation process. Distributed or localized allocations of one sub-carrier block can be changed dynamically from one group of symbol-duration time spans to the other.

The method of the invention can be used in downlink resource allocation as well as in uplink resource allocation. Even though the following description will concentrate on downlink resource allocation, it will be obvious to a person skilled in the art, that the method and its embodiment can also be used for uplink resource allocation. The corresponding resource allocation signalling for the uplink resource allocation is sent in downlink transmission.

Preferred embodiments of the allocation method of the first aspect of the invention will be described in the following. Unless stated explicitly, the described embodiments can be combined with each other.

A preferred embodiment comprises generating a control signal and transmitting a control signal to the terminals in the network cell using a common control channel, the control signal including an allocation table containing an allocation-table header and a plurality of allocation-table entries.

By using a common control channel for transmitting the control signal that provides the allocation of the resource blocks during the group of consecutive symbol-duration time spans, the allocation is communicated to all active terminal devices in the network cell. By using an allocation table containing an allocation-table header and a plurality of allocation-table entries, a basic and simple signalling of the allocations is provided, which keeps the overhead small. The allocation-table structure thus enables an efficient control signalling for resource allocation, in that each terminal device only needs to read the allocation-table header and only that allocation-table entry, which is targeted to the respective terminal device.

Several alternative embodiments that make advantageous use of this basic structure will be explained in the following.

In a first alternative embodiment that further specifies the structure of the allocation table, generating of the control signal comprises including a plurality of first sub-carrier-block type indicators in the allocation-table header. Each first sub-carrier-block type indicator indicates whether an allocation of a respective sub-carrier block is a localized allocation or a distributed allocation to a respective terminal device. This way, each sub-carrier block during a current group of consecutive symbol-duration time spans is uniquely identified as being allocated according to either a localized-type or a distributed type allocation. By way of example, the first sub-carrier-block type indicator indicates, for which allocation types a specific sub-carrier-block is used in all symbols of one sub-frame. Therefore, for a localized allocation type, there can be only one allocation, but for a distributed allocation type, there would be several allocations.

The first sub-carrier-block type indicator can take the form of an indicator bit. This way, a particularly small amount of signalling is required. For instance, a first sub-carrier-block type indicator bit with the value “0” indicates that a sub-carrier block is used for a localized allocation, and a value of “1” indicates that the corresponding sub-carrier block is used for distributed allocations.

By ordering the first sub-carrier-block type indicator bits in the form a bit sequence, in which the order corresponds to an order of sub-carrier blocks in the frequency spectrum to be allocated, a unique and simple way of signalling the allocation for the current group of consecutive symbol-duration time spans can be implemented.

In a second alternative embodiment, which further specifies the structure of the allocation table, the generating of the control signal comprises including a plurality of second sub-carrier-block type indicators in the allocation-table header. Each second sub-carrier-block type indicator indicates whether an allocation with the same allocation type, localized or distributed, of a respective next sub-carrier block is to the same terminal device or not. Thus, the second sub-carrier-block type indicator provides information on whether the allocation continues to the next sub-carrier block of the same allocation type or not. The next sub-carrier block is the next one in the order of sub-carrier blocks in the frequency domain. A terminal device that reads the header of the allocation table will thus know whether the next sub-carrier block that is allocated according to the same allocation type, localized or distributed, will again be allocated to the same terminal device. For instance, a second sub-carrier-block type indicator bit with the value “0” indicates that the next sub-carrier block of the same allocation type is not to the same terminal device, and a value of “1” indicates that the next sub-carrier block of the same allocation type is to the same terminal device.

The present alternative embodiment is useful in a system where only one of the localized or the distributed allocation type is used. In this case, only the second sub-carrier-block type indicator is sufficient to indicate the resource allocation to terminal devices.

In a third alternative embodiment, which forms a preferred combination of the first and second alternative embodiments described in the preceding paragraphs, the generating of the control signal comprises including a plurality of sub-carrier-block type indicator pairs in the allocation-table header. Each sub-carrier-block type indicator pair consists of a first and a second sub-carrier-block type indicator. The first sub-carrier-block type indicator of a respective sub-carrier-block type indicator pair indicates whether an allocation of a respective sub-carrier block is a localized allocation or a distributed allocation to a respective terminal device The second sub-carrier-block type indicator of a respective sub-carrier-block type indicator pair indicates whether an allocation having the same allocation type, localized or distributed, of a respective next sub-carrier block is to the same terminal device or not.

In this embodiment two bits are preferably used as a control signal for the allocation of one respective sub-carrier block during the group of consecutive symbol-duration time spans. The complete set of sub-carrier-block type indicator pairs can be arranged in the form of a bit sequence in the allocation-table header. In each indicator pair, the first bit indicates, whether a respective sub-carrier block is used for a localized or a distributed allocation. The second indicator bit indicates whether an allocation of the same allocation type, localized or distributed, continues to the next sub-carrier block for the same terminal device or not. As a example, the following sub-carrier-block type indicator bit pairs are provided in one specific embodiment:
00: The sub-carrier block is used for localized allocation, and the next localized sub-carrier block does not belong to the same terminal device.
01: The sub-carrier block is used for localized allocation, and the next localized sub-carrier block belongs to the same terminal device.
10: The sub-carrier block is used for distributed allocation, and the next distributed sub-carrier block does not belong to the same terminal device.
11: The sub-carrier block is used for distributed allocation, and the next distributed sub-carrier block belongs to the same terminal device.

The method of the invention is particularly suited for frequency-division multiple access systems like frequency-division multiple access (FDMA) or orthogonal frequency-division multiple access (OFDMA) systems. FDMA is currently considered to be used for E-UTRAN. In (O)FDMA, a sub-carrier block is formed by a group of consecutive sub-carriers, and a symbol is composed of the complete number of sub-carriers during a symbol-duration time span, or in other words, by all resource blocks of the available bandwidth.

Preferably, the group of symbol-duration time spans equals the duration of a sub-frame. This means that the allocation method of the invention performs an allocation on a sub-frame-by-sub-frame basis. Even though this is the preferred way of using the invention, it is also possible to reduce the frequency of resource allocation, e. g., to one allocation per frame. However, it should be kept in mind that this will reduce the possibilities of dynamic adaptation of resource allocation, and therefore reduce the efficiency of the organization of multi-carrier transmission resources in a network cell.

A sub-carrier block preferably comprises between 20 and 40 sub-carriers. A preferred example uses 25 sub-carriers.

The transmission resources are preferably adapted to the particular standard and typically cover a frequency spectrum of up to 20 MHz width in the frequency domain. However, the invention is applicable for smaller and larger bandwidth values as well.

In a further preferred embodiment, the allocation comprises a first allocating, in which at least one allocation of the localized-allocation type is performed, and a second allocating, in which at least two allocations of the distributed-allocation type are performed. This allocation scheme allows to use the full bandwidth without using puncturing.

In the following, further preferred embodiments regarding the allocation-table structure for use in the method of the invention will be described.

In one preferred embodiment, the number of allocation-table entries corresponds to the number of active terminal devices in the network cell. An active terminal device is a terminal device, which is currently using transmission resources. Allocation of resources need not be done for terminal devices, which are not active.

Preferably, the generating of a control signal comprises including a respective terminal-device identifier in each allocation-table entry, and ordering the allocation-table entries in accordance with an order of resource blocks in the frequency domain. The respective terminal-device identifier in each allocation table-entry enables the active terminal devices to quickly find their respective resource allocation in the control signal without having to read the complete number of allocation-table entries. The ordering of the allocation-table entries enables a respective terminal device to know the allocated sub-carrier block for the current sub-frame. This embodiment therefore provides a particularly low signalling overhead for resource allocation. Preferably, also the sub-carrier-block type indicator pairs in the allocation-table header are generated in the same order, that is in accordance with the order of resource blocks in the frequency domain. In combination with the previous embodiment, this enables a terminal device to identify not only the allocated sub-carrier block in very simple manner, but also the type of allocation and information on continuation of this type of allocation, as explained before.

The signalling can be further reduced in an embodiment, wherein the allocation, in case a distributed-allocation type, includes cyclically allocating a subcarrier block in consecutive symbol-duration time spans to the set of terminal devices. By including the cyclic distributed allocation in system specifications, terminal devices as well as a network node performing the allocation will assume the cyclic allocation of resource blocks in consecutive symbol-duration time spans so that even for distributed allocation, no further signalling needs to be included in the allocation-table header. This further increases the ability to dynamically control the resource allocation during network operation.

In a further preferred embodiment, in case of a distributed-allocation type, the allocating includes allocating a plurality of resource blocks. Distributed allocation to the set of terminal devices is in this embodiment performed cyclically over the plurality of resource blocks and the group of consecutive spans in the cyclic allocation. The transmission resources are partitioned into sub-bands in the frequency domain. The allocating is performed for each sub-band separately.

Before turning to another group of preferred embodiments, some introductory explanation will be given next below. Known transmission systems provide transmission resources that consists of multiple sub-bands. For example, in E-UTRAN, a power-coordination-based interference mitigation relies on a frequency-reuse pattern using a sub-band structure. In addition, terminal devices may have different bandwidth capabilities, which requires to divide the system bandwidth of the transmission resources of a network cell to be divided into several sub-bands. For instance, a 20 MHz system bandwidth may have to be divided into 10 MHz sub-bands. More specifically:

a) Inter-cell interference mitigation may be achieved by power coordination of neighboring cells. The system bandwidth in such a power-coordination scheme may be divided into multiple sub-bands. The maximum transmission power of the neighboring cells on the same sub-bands are coordinated so that the interference is minimized at the cell edge. However, since the allocation table needs to be received correctly also at the cell edge, a power coordination should be applied to both, the data part and the control signalling part, the latter including the signalling for allocation, so as to increase the signal-to-noise ratio of the signals. Since terminal devices at a cell edge will have difficulties in receiving the control signal information, which is physically mapped onto the sub-bands with small transmission power, it is required to provide a detectable and decodable allocation control signal within each sub-band.

b) The bandwidth capability of the terminal devices may be smaller than the system bandwidth. Suppose there is a terminal device with a 10 MHz-capability in a system with 20 MHz bandwidth. All necessary control information for the terminal device with 10 MHz bandwidth, which is required for the terminal device to know its allocated resources, should also be physically mapped onto the same 10 MHz sub-band. Of course, this applies also to terminal devices with even smaller bandwidth capability.

In such systems, control signals for resource allocation must be detectable and decodable within each sub-band.

In the following, therefore, preferred embodiments of the method of the invention will be provided, which allow a network entity flexibly designing detectable and decodable allocation tables for each sub-bands, and to notify them to the respective terminal devices.

According to one such preferred embodiment, where the transmission resources are partitioned into the sub-bands in the frequency domain, the allocation is performed for each sub-band separately. Preferably, generating and transmitting the control signal containing the allocation table are performed on each sub-band separately.

Embodiments, which use a second sub-carrier-block type indicator, as described above, can be adapted to a system with sub-band as follows, a second sub-carrier-block type indicator, which is associated with a last sub-carrier block of a first sub-band is preferably used to indicate whether an allocation having the allocation type, localized or distributed, of a first sub-carrier block of a neighboring second sub-band is to the same terminal device or not.

Note that it is a matter of definition whether an independent allocation table is included in the signalling for each sub-band or whether the allocation table is considered as an entity that extends over several sub-bands and contains a corresponding number of allocation-table headers, one for each sub-band. In the following, it will be assumed without restriction that an independent allocation table is provided for each sub-band.

In case of an allocation of the distributed allocation type, the allocating is preferably restricted to a respective sub-band and includes allocating the at least one sub-carrier block within the group of symbol-duration time spans in a cyclic manner to a number of terminal devices. Thus, the cyclic distribution, which has already been explained earlier, is restricted to each sub-band.

Even if a distributed allocation uses resource blocks belonging to different sub-bands, each sub-carrier block follows its cyclic distribution within each sub-frame. Therefore, no signalling is needed to indicate how an allocation of the distributed type is actually distributed. The scheme of this embodiment allows maintaining the cyclic distribution rule for both, terminal devices, which are limited to one sub-band, and terminal devices, which can utilize several sub-bands simultaneously.

The method of the invention is not restricted to systems with a large band-width such as 20 MHz. However, for systems with smaller bandwidth, such as 1.25 MHz or 2.5 MHz, additional modifications can be advantageous, as will be explained in the following. It is noted that the following embodiments may, however, also be useful in systems with large bandwidth.

In systems with small bandwidth the overhead required for the allocation table is not negligible. Also, the overhead of a MAC header required for segmentation is not negligible in this case. In an indoor environment, coverage problems may occur if a packet is segmented and transmitted in a different subframe. Therefore, preferred embodiments of the allocation method of the invention make use of a dynamic control of an allocation length in order to avoid segmentation.

In one such preferred embodiment, which forms a first alternative, the allocation comprises allocating a long allocation block being formed by a plurality of successive allocation blocks according to an either localized or distributed allocation type. An allocation block is formed by the group of symbol-duration time spans in the time domain and the at least one respective sub-carrier block in the frequency domain. In this embodiment, therefore, allocation can be extended to a plurality of allocation blocks, which helps avoiding segmentation.

A preferred implementation of this embodiment comprises including into the allocation-table header a plurality of first allocation-block type indicators indicating whether or not a respective current allocation block is a first allocation block of a long allocation block.

An alternative second embodiment comprises including into the allocation-table header a plurality of second allocation-block type indicators indicating whether or not a respective long allocation block continues in a respective subsequent allocation block.

A third alternative embodiment, which implements a preferred combination of the two previous alternatives, comprises including into the allocation-table header a plurality of allocation-block type indicator pairs, each allocation-block type indicator pair comprising a first allocation-block type indicator indicating whether or not a respective current allocation block is a first allocation block of a long allocation block, and each second allocation-block type indicator indicating whether or not a respective long allocation block continues in a respective subsequent allocation block. The first allocation-block type indicator can also be used for blank resource blocks, which are not allocated to any terminal devices. This maintains flexibility of scheduling. As an example, the following allocation-block type indicator pairs, as represented by two consecutive bits, represent the following information in one preferred embodiment:
11: First sub-frame of a long allocation block
01: Middle sub-frame of a long allocation block
00: Last sub-frame of a long allocation block
10: Allocation block using only one sub-frame.

Only the first allocation-block type indicator is sufficient if long allocation blocks are only used for localized allocations.

A further preferred embodiment comprises dynamically changing the number of resource blocks of consecutive allocation blocks in a long allocation block.

That means, the size of an allocation block can for instance be changed sub-frame by sub-frame if necessary, for both localized and distributed allocation types.

According to a second aspect of the invention, an allocation-control device for localized or distributed allocation of multi-carrier transmission resources to terminal devices in a network cell of a radio access network is provided. The allocation-control device is configured to allocate to a respective terminal device a group of consecutive symbol-duration time spans in the time domain and at least one respective sub-carrier block in the frequency domain, the at least one respective sub-carrier block being formed by a group of respective consecutive sub-carriers.

The allocation-control device is further configured to allocate a respective sub-carrier block and the group of consecutive symbol-duration time spans according to one respective allocation type, which is either a localized or a distributed allocation type, the localized allocation type allocating them to one respective terminal device, and the distributed allocation type allocating them to a respective set of terminal devices.

The allocation-control device of the second aspect of the invention implements the method of the first aspect of the invention.

The allocation-control device can take the form of an add-on module to a network node of a radio access network. It may also form an integral part of a network node, such as a node B. As mentioned before, the allocation-control device may be configured to allocate transmission resources in downlink or uplink. The allocation-control device may also form a part of a radio network controller (RNC).

The following preferred embodiments of the allocation-control device of the invention correspond to embodiments of the method of the invention, which have been explained earlier. Therefore, the explanation is kept short and reference is made to the above description of the method aspects of the invention.

In one embodiment, the allocation-control device is further configured to generate an allocation table containing an allocation-table header and a plurality of allocation-table entries.

In one embodiment, the allocation-control device of the previous embodiment is further configured to include in the allocation-table header a plurality of first sub-carrier-block type indicators, each indicating whether an allocation of a respective sub-carrier block to a respective terminal device is of the localized-allocation type or of the distributed-allocation type.

In one embodiment, which forms an alternative to the previous embodiment, the allocation-control device is further configured to include in the allocation-table header a plurality of second sub-carrier-block type indicators, each second sub-carrier-block type indicator indicating whether an allocation with the same allocation type, localized or distributed, of a respective next sub-carrier block is to the same terminal device or not.

Preferably, the previous two alternative embodiments are combined in an allocation-control device, which is further configured to include in the allocation-table header a plurality of sub-carrier-block type indicator pairs in the allocation-table header, each sub-carrier-block type indicator pair being formed by a first and a second sub-carrier-block type indicator, the first sub-carrier-block type indicator of a respective sub-carrier-block type indicator pair indicating whether an allocation of a respective sub-carrier block is a localized allocation or a distributed allocation to a respective terminal device, the second sub-carrier-block type indicator of a respective sub-carrier-block type indicator pair indicating whether an allocation having the same allocation type, localized or distributed, of a respective next sub-carrier block is to the same terminal device or not.

Another embodiment of the allocation-control device is further configured to generate a respective allocation table in connection with each group of consecutive symbol-duration time spans. Preferably, the allocation-control device is configured to map a respective allocation table onto a first symbol of a respective sub-frame.

In another embodiment, the allocation-control device is configured to include a as many allocation-table entries in the allocation table as there are active terminal devices in the network cell. Preferably, the allocation-control device is configured to include a respective terminal-device identifier in each allocation-table entry, and to set an order of the allocation-table entries in accordance with an order of resource blocks in the frequency domain. In an embodiment, which uses sub-carrier-block indicator pairs, the allocation-control device is preferably configured to include the sub-carrier-block type indicator pairs in the allocation-table header in an order that is in accordance with an order of resource blocks in the frequency domain.

In another embodiment, the allocation-control device is configured to cyclically allocate a sub-carrier block in consecutive symbol-duration time spans to the set of terminal devices in case of a distributed-allocation type. In one embodiment, the allocation-control device is configured to allocate a plurality of resource blocks, and to perform a distributed allocation to the set of terminal devices cyclically over the plurality of resource blocks and the group of consecutive spans.

In one embodiment, the allocation-control device is configured to allocate a respective sub-carrier block and the group of consecutive symbol-duration time spans for each of a plurality of sub-bands in the frequency domain separately.

In another embodiment, the allocation-control device is further configured to allocate a long allocation block being formed by a plurality of successive allocation blocks according to an either localized or distributed allocation type, an allocation block being formed by the group of symbol-duration time spans in the time domain and the at least one respective sub-carrier block in the frequency domain.

In one embodiment, the allocation-control device is further configured to generate and include into the allocation-table header a plurality of first allocation-block type indicators indicating whether or not a respective current allocation block is a first allocation block of a long allocation block.

In another embodiment, the allocation-control device is further configured to generate and include into the allocation-table header a plurality of second allocation-block type indicators indicating whether or not a respective long allocation block continues in a respective subsequent allocation block.

In another embodiment, the allocation-control device is further configured to generate and include into the allocation-table header a plurality of allocation-block type indicator pairs, each allocation-block type indicator pair comprising a first allocation-block type indicator indicating whether or not a respective current allocation block is a first allocation block of a long allocation block, and each second allocation-block type indicator indicating whether or not a respective long allocation block continues in a respective subsequent allocation block.

In one embodiment, the allocation-control device is further configured to dynamically change the number of resource blocks of consecutive allocation blocks in a long allocation block.

In a further embodiment, the allocation-control device is configured as an addon module to a network node of a radio access network.

According to a third aspect of the invention a control signal is provided for localized or distributed allocation of multi-carrier transmission resources, which comprise a plurality of sub-carriers, to terminal devices in a network cell of a radio access network, the control signal encoding an allocation table containing an allocation-table header and a plurality of allocation-table entries, wherein the allocation-table header contains
either a plurality of first sub-carrier-block type indicators, each indicating whether an allocation of a respective resource block, which consists of a group of respective sub-carriers, is a localized allocation or a distributed allocation to a respective terminal device,
or a plurality of second sub-carrier-block type indicators, each indicating whether an allocation having the same allocation type, localized or distributed, of a respective next sub-carrier block is to the same terminal device or not,
or a plurality of sub-carrier-block type indicator pairs, each being formed by a first and a second sub-carrier-block type indicator, the first sub-carrier-block type indicator of a respective sub-carrier-block type indicator pair indicating whether an allocation of a respective sub-carrier block is a localized allocation or a distributed allocation to a respective terminal device, the second sub-carrier-block type indicator of a respective sub-carrier-block type indicator pair indicating whether an allocation having the same allocation type, localized or distributed, of a respective next sub-carrier block is to the same terminal device or not.

The control signal of the present aspect of the invention achieves a substantive reduction of overhead in control signalling for allocating transmission resources to terminal devices in a network cell of a radio access network. The signal also helps increasing the flexibility and enables a dynamic adaptation of the allocation on a sub-frame-by-sub-frame basis. The control signal provides a unified format for all terminal devices.

In a preferred embodiment, the control signal comprises the allocation-table header appended to that allocation-table entry, which is transmitted first in the control signal. This way, the allocation-table entry and the allocation-table header form a unified entry format for the allocation table. After decoding the first allocation-table entry and the header, all receivers in the network cell are able to decode their respective entries.

Preferably, the allocation-table entry, which is transmitted first, comprises a self-decodable channel coding block with error detection. This way, the important entry section of the control signal is well protected and can be decoded by all active terminal devices in the network cell.

In a preferred embodiment, each allocation-table entry comprises a terminal device identifier. The order of allocation-entries in this embodiment corresponds to an order of resource blocks in the frequency domain. This way, no further signalling is needed to uniquely assign resource blocks.

Preferably, the allocation table for a respective sub-frame is mapped onto the first symbol of the sub-frame.

For operation in a system with different sub-bands, the control signal of the invention preferably comprises a sub-band identifier. The sub-band identifier can be contained in the allocation-table header in order to enable all active terminal devices to correctly locate their sub-band and the corresponding band-allocation table. In a further embodiment, the control signal further comprises a first-sub-carrier-block identifier for indicating a frequency of the first sub-carrier of a first sub-carrier block in a sub-band. Given a predetermined number of sub-carriers per resource block, the terminal devices are enabled to precisely locate all resource blocks of a sub-band from this information contained in the control signal.

According to a fourth aspect of the invention, a control unit for a terminal device to be operated in a radio access network is provided. The control unit comprises a allocation-table evaluation unit, which is configured to decode a received control signal for localized or distributed allocation of multi-carrier transmission resources, which comprise a plurality of sub-carriers, to terminal devices in a network cell of the radio access network, and to decode from the control signal an allocation table containing an allocation-table header, wherein the allocation-table header contains
either a plurality of first sub-carrier-block type indicators, each indicating whether an allocation of a respective resource block, which consists of a group of respective sub-carriers, is a localized allocation or a distributed allocation to a respective terminal device,
or a plurality of second sub-carrier-block type indicators, each indicating whether an allocation having the same allocation type, localized or distributed, of a respective next sub-carrier block is to the same terminal device or not,
or a plurality of sub-carrier-block type indicator pairs, each being formed by a first and a second sub-carrier-block type indicator, the first sub-carrier-block type indicator of a respective sub-carrier-block type indicator pair indicating whether an allocation of a respective sub-carrier block is a localized allocation or a distributed allocation to a respective terminal device, the second subcarrier-block type indicator of a respective sub-carrier-block type indicator pair indicating whether an allocation having the same allocation type, localized or distributed, of a respective next sub-carrier block is to the same terminal device or not.

The allocation-table evaluation unit is further configured to evaluate the allocation-table header to locate and decode an allocation-table entry, which is associated with the terminal device.

### BRIEF DESCRIPTION OF THE DRAWINGS

FIG. 1 shows a schematic representation of an OFDM symbol and is used for explaining the term resource block.

FIG. 2 shows the structure of an allocation table used for control signalling according to the method of the invention.

FIG. 3 is a schematic chart for explanation of the relation between the order of resource blocks in an OFDM symbol, the order of sub-carrier-block type indicator pairs in the allocation-table header and the order of entries in the allocation table, according to a preferred embodiment of the invention.

FIG. 4 is a chart explaining the order of resource allocation according to a preferred embodiment of the invention.

FIGS. 5a) and b) show examples of allocation tables for different sub-bands according to another embodiment of the invention.

FIG. 5c) shows an allocation of resource blocks in the two sub-bands of FIGS. 5a) and b) in a sub-frame, according to the same embodiment as that of FIGS. 5a) and b).

FIGS. 6a) and b) show consecutive sub-frames in an embodiment that uses allocation-block type indicators for dynamically changing the allocation-block type between sub-frames.

FIG. 7 shows another example of a sub-frame that is generated due to allocation of blank allocations.

FIG. 8 shows an embodiment of a radio access network cell that comprises an allocation control device according to an embodiment of the invention, and terminal devices with a control unit according to the invention.

### DESCRIPTION OF PREFERRED EMBODIMENTS

In a preferred embodiment of the present invention, a signalling method for a common control channel is used that provides an allocation table with a unified entry format with a self-decodable channel-coding block arrangement for common control signalling having variable and dynamic configurations of shared allocations.

The embodiment uses a unified allocation table format so that only the first entry (of known size) in the table is always encoded in a specific way, wherein after decoding a terminal device can understand the size and channel coding block structure of the remaining part(s) of the allocation table, which may be of any size or any format.

The allocation table preferably includes a unified entry for every allocation of a receiver in that frame. There are two aspects involved, first the information contents of the allocation table vary as a function of the number of entries per allocation table, and second the allocation table has to be decodable by all terminal devices despite their expected received symbol energy to interference power. In both aspects, the channel coding block of the allocation table has to be either known beforehand, or has to be blind-detectable or has to be signalled outside of the allocation table itself.

It is notable also that commonly applied retransmission techniques such as hybrid ARQ and incremental redundancy are not applicable for this kind of common control signaling.

The channel coding block of the allocation table is defined to have two parts. A first part is always coded in a unified self-decodable format, which then reveals the format of the latter channel coding block(s). The first part thus always includes a defined number of information bits and defined ratio of redundancy, which results a uniquely defined length channel coded block. The latter coding block allows variable information contents, variable number of information bits and variable channel coding rate, as those are identified uniquely in the first part of the allocation table.

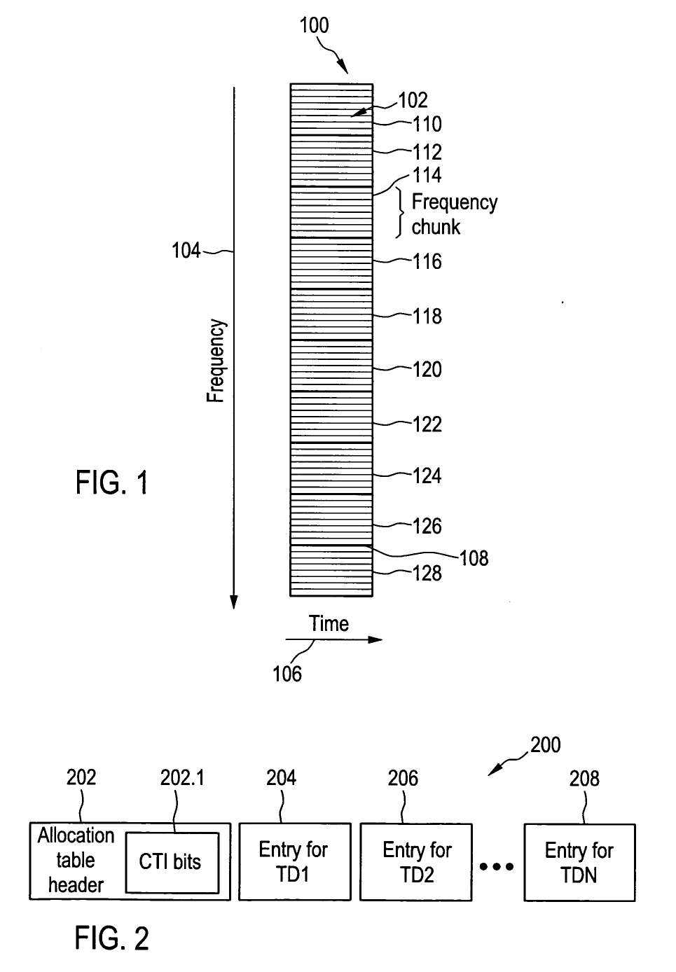

FIG. 1 shows a schematic representation of an OFDM symbol and is used for explaining the term sub-carrier block.

FIG. 1 shows an OFDM symbol 100 in a representation that points up a main concept underlying the allocation-control method of a preferred embodiment of the invention. The OFDM symbol, as is well known in the art, comprises a plurality of sub-carriers 102. The representation of FIG. 1 uses a vertical access 104 to indicate increasing frequency values. A horizontal access 110 represents the time. As indicated by bold horizontal lines such as that labeled 108, the OFDM symbol 100 is for the purpose of the allocation method of the present invention divided into a number of frequency-resource blocks, which are herein also be referred to as sub-carrier block and as sub-carrier chunks with the same meaning.

In FIG. 1, the OFDM symbol 100 consists of 10 sub-carrier blocks 110 to 128. The number of 10 sub-carrier blocks is of pure exemplary nature. The number of sub-carrier blocks should be chosen in view of the spectral bandwidth covered by the complete set of sub-carriers 102, which form the spectral resource to be allocated. As a rough target, one sub-carrier block could for instance consist of 25 sub-carriers. Given spectral resources of 20 MHz width, 48 sub-carrier blocks is the maximum number.

The present embodiment of the invention is based on an allocation concept according to which localized allocation and distributed allocation do not share the same sub-carrier block in one sub-frame. As is well known, a sub-frame (not shown in FIG. 1) consists of a pre-determined number of OFDM symbols 100, such as for instance 5 OFDM symbols.

The allocation concept of the present embodiment, which is based on allocating sub-carrier blocks either in a localized- or in a distributed-type allocation, provides for sub-carrier selection across the complete spectral bandwidth. Any of the sub-carrier blocks 110 to 128 can be used for either a localized or a distributed allocation. This allows providing a sufficient frequency diversity to distributed allocations.

As explained before, a distributed allocation uses non-consecutive sub-carriers. According to the method of the invention, a distributed allocation allocates sub-carrier blocks and does not further divide the sub-carrier blocks into smaller groups or into single sub-carriers for further distribution. In case a sub-carrier block covers approximately the coherent bandwidth, distributing the allocation into two or three different sub-carrier blocks results in good diversity gain.

FIG. 2 shows a representation of an allocation table 200, which is used for control signalling according to a preferred embodiment of the invention. The allocation table comprises an allocation-table header 202 and a number of allocation-table entries, three of which are labeled 204, 206 and 208.

The information content of the allocation table is not constant but depends on the number of entries present in the allocation table. The allocation-table header is therefore needed in the first part of the allocation table to exactly indicate the length of the actual channel coding block of the second part of the allocation table.

The allocation-table header can be appended to the first entry of the allocation table, which is a single entry and thus always of a-priori known size. In order to correctly decode the header, the first entry needs to be well protected and it needs to be a self-decodable channel coding block with error detection. The first entry and the header thus form a unified entry format for the full allocation table. After decoding the first entry and the header, a terminal device is able to decode all other entries, if present.

In OFDMA multi-carrier systems, where each time domain symbol consists of several frequency domain sub-carriers, the block length of the first part of the allocation table can be dimensioned to fit one full time domain symbol. However, it is more feasible to frequency interleave this allocation table with the pilot sequence to the same time symbol. This allows very accurate channel estimation for reliable decoding of the first part of the allocation table. Thus, the preferred length of a self-decodable block (first part) of the allocation table equals exactly the samples of one time domain symbol subtracted by the samples dedicated for a pilot sequence.

Once the allocation table entries are formed, the block of bits will be channel-coded and modulated to OFDM resources. These resources may be given as full OFDM symbols in time, as the number of sub-carrier symbols in frequency over a given OFDM symbol in time, or as a given number of sub-carrier symbols in frequency over a given number of OFDM symbols in time.

Allocation-table header in the first part of the table could define for the second part of the table, e.g. type of channel code: turbo, convolutional, etc; channel coding rate: 1/3, 1/2, . . . ; indication if outer code is in use: yes/no; type of the outer-code: Reed Solomon, Golay, Hamming or other block code; block length of the block code; type of error detection: CRC; length of error detection: 12 bits; channel coded block length; number of entries.

According to the present preferred embodiment of the invention, the allocation-table header 202 contains a plurality of chunk-type indicator bits in a section 202.1.

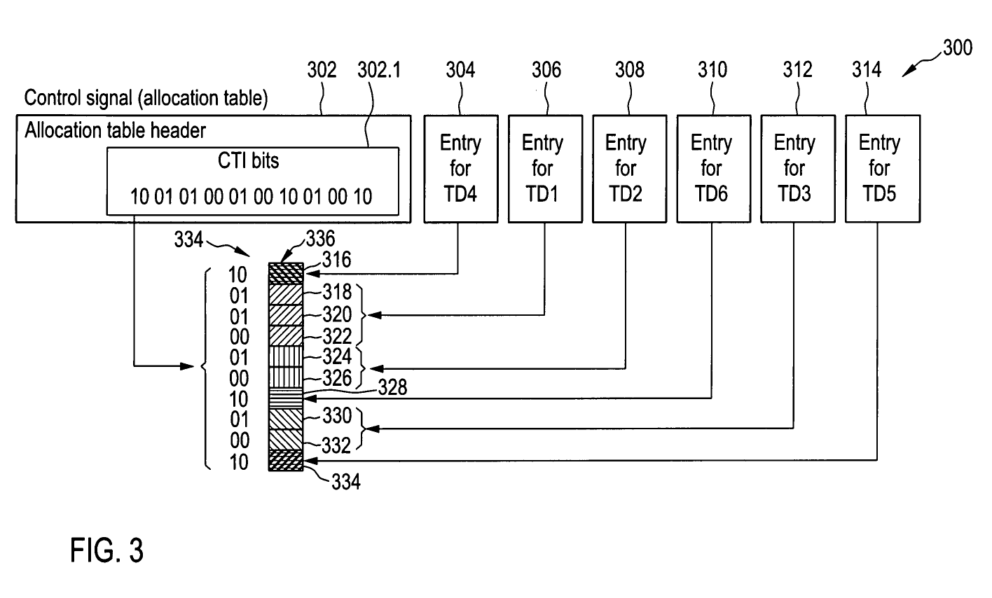

In the section 202.1 a pair of two sub-carrier-block type indicator bits is used for each sub-carrier block. The sub-carrier-block type indicator bits are also referred to as chunk-type indicator bits or CTI bits herein. The detailed structure of the bit sequence formed in section 202.1 of allocation-table header will be explained below in the context of FIG. 3.

The allocation table-entries 204 to 208 each have an identical structure and each contain a terminal device identifier. A typical size for a terminal device identifier is 9 bits. However, a larger number of identifier bits can be used to cover a larger number of terminal devices in a network cell. When using 11 bits and 48 chunks per 20 MHz spectral bandwidth, 1920 voice-over-IP users can be accommodated within one network cell, assuming time slots of 20 ms, i. e. 40 sub-frames. Furthermore, each entry contains TFI (transmission format indicator) bits and HARQ control bits. Additional entry items may be contained in the entries 204 to 208, but the mentioned ones are required in the present preferred embodiment.

Note that the location of the allocated resource, the size of the allocated resource, and the pattern of the distributed allocation need not be signaled in each entry.

In a preferred embodiment both localized and distributed allocations use the same entry structure in the allocation table 200.

FIG. 3 shows a chart for a further explaining the use of chunk-type indicator bits according to a preferred embodiment of the invention. An allocation-table 300 is shown. The structure of allocation table 300 resembles that shown in

FIG. 2 for allocation table 200. An allocation-table header 302 contains a section 302.1 that is formed by chunk-type indicator bits. An exemplary CTI bit sequence is shown: 10010100010010010010. The meaning of this chunk-type indicator bit sequence will be explained further belong. The allocation table 300 further contains a number of entries. In the present example, six entries 304 to 314 are shown. As can be seen, the ordering of the entries does not correspond to a numbering of the terminal devices, but follows an order of sub-carrier blocks 316 to 332 of a sub-frame 334, which is represented by a single OFDM symbol 336 in FIG. 3 for reasons of clarity.

As is indicated by connecting arrows between the entries 304 to 314 of the allocation table and respective frequency chunks of the OFDM symbol 336, sub-carrier block 316 is allocated to terminal device 4, sub-carrier blocks 318 to 322 are allocated to terminal device 1, sub-carrier blocks 324 and 326 are allocated to terminal device 2, sub-carrier block 328 is allocated to terminal device 6, sub-carrier blocks 330 and 332 are allocated to terminal device 3, and sub-carrier block 334 is allocated to terminal device 5.

Therefore, the order of entries in the allocation table corresponds to the order of allocations in the frequency domain. The number of allocated sub-carrier blocks and the allocation type distributed or localized, can derived by each terminal device from the chunk-type indicator bit sequence in section 302.1 of the allocation-table header 302. This will be explained in the following. The sequence of chunk-type indicator bits is composed of chunk-type indicator pairs. A first chunk-type indicator bit of each chunk-type indicator pair indicates whether an allocation of a respective sub-carrier block is a localized allocation or a distributed allocation to a respective terminal device. In the present embodiment, the bit value 0 of the first chunk-type indicator bit means that a sub-carrier block is used for a localized allocation, and a bit value of 1 of the first chunk-type indicator bit means that a sub-carrier block is used for a distributed allocation.

The second chunk-type indicator bit of each chunk-type indicator pair indicates whether or not an allocation of the same allocation type, i. e., localized or distributed, as the present allocation of a respective next sub-carrier block is to the same terminal device or not. In the present embodiment, the bit value 0 of the second chunk-type indicator bit means that a next localized subcarrier block is not allocated to the same terminal device, and a bit value of 1 of the second chunk-type indicator bit means that a next sub-carrier block of the same allocation type does belong to the same terminal device.

Therefore, the following four bit pairs can be formed to indicate the allocation type for a particular sub-carrier block:
00: The sub-carrier block is used for localized allocation, and the next localized sub-carrier block does not belong to the same terminal device.
01: The sub-carrier block is used for localized allocation, and the next localized sub-carrier block belongs to the same terminal device.
10: The sub-carrier block is used for distributed allocation, and the next distributed sub-carrier block does not belong to the same terminal device.
11: The sub-carrier block is used for distributed allocation, and the next distributed sub-carrier block belongs to the same terminal device.

Accordingly, in the example of FIG. 3, the sub-carrier block 316 is used for distributed allocation and the next distributed sub-carrier block is not allocated to the same terminal device, which is terminal device 4. This way, terminal device 4 is instructed not to make use of the next sub-carrier block that is subject to distributed allocation, which is sub-carrier block 328 (as can be seen from the first chunk-type indicator bits). The sub-carrier block 318 is associated with a chunk-type indicator pair 01. This means, that sub-carrier block 318 is subject to an allocation of the localized type, and that the next sub-carrier block of the localized-allocation type is allocated to the same terminal device, which is terminal device 1. This next sub-carrier block 320 is associated with the same pair of chunk-type indicators, so that sub-carrier block 322 is also allocated to terminal device 1 in a localized manner. However, since the chunk-indicator pair associated with sub-carrier block 322 is 00, terminal device 1 is instructed that the next sub-carrier block of the localized type is allocated to another terminal device.

In a similar way, the remaining chunk-type indicator pairs, which are associated with the sub-carrier blocks 324 to 334 are interpreted by the terminal devices. Since the order of the chunk-type indicator pairs corresponds to the order of the sub-carrier blocks in the sub-frame 334, no additional signalling is required to perform the resource allocation. In other words, the order of the allocated sub-carrier blocks in the frequency domain corresponds to the order of the chunk-type indicator pairs in the allocation-table header section 302.1.

This order correspondence gives the information of the targeted terminal devices about allocated sub-carrier blocks. No other signalling is required to indicate the targeted terminal devices.

Therefore, the order of the allocated sub-carrier blocks in the frequency domain of a certain OFDM symbol corresponds to the order of the allocation entries in the allocation table. The OFDM symbol can for example be the first OFDM symbol. However, the order of resource allocation in the frequency domain of other symbols can be different. This is explained in the following:

For each localized allocation, the same sub-carrier blocks of other symbols within one sub-frame are also used for the same terminal device. On the other hand, for each distributed allocation, one terminal device uses different sub-carrier blocks in different symbols by using a sub-carrier-chunk-based hopping. The hopping is restricted so that only the sub-carrier blocks for distributed allocation can be used. However, there is freedom on how to distribute it within this restriction.

As an example, in distributed allocations, data are distributed to the whole available sub-carrier blocks allocated for the distributed allocation within one sub-frame in a cyclic hopping manner. No signalling is needed to indicate how the distributed allocation is distributed. For instance, one of the following items can be a priory determined and agreed between the network and the terminal devices by means of a specification or by means of higher-layer signalling.

Assuming that a sub-carrier block for localized allocation and a sub-carrier for distributed allocations are referred to as L-chunk and D-chunk, respectively, frequency hopping is done cyclically with a step size of K sub-carrier blocks. Note that L-chunks are skipped in this hopping scheme.

a) K+1, where the i-th D-chunk in the first data symbol, the (i+1)-st D-chunk in the second data symbol, the (i+2)-nd D-chunk in the third data symbol, etc. are used for one distributed allocation.

b) Assuming that there are J D-chunks, K is set to the minimum integer that is larger than or equal to J/5.

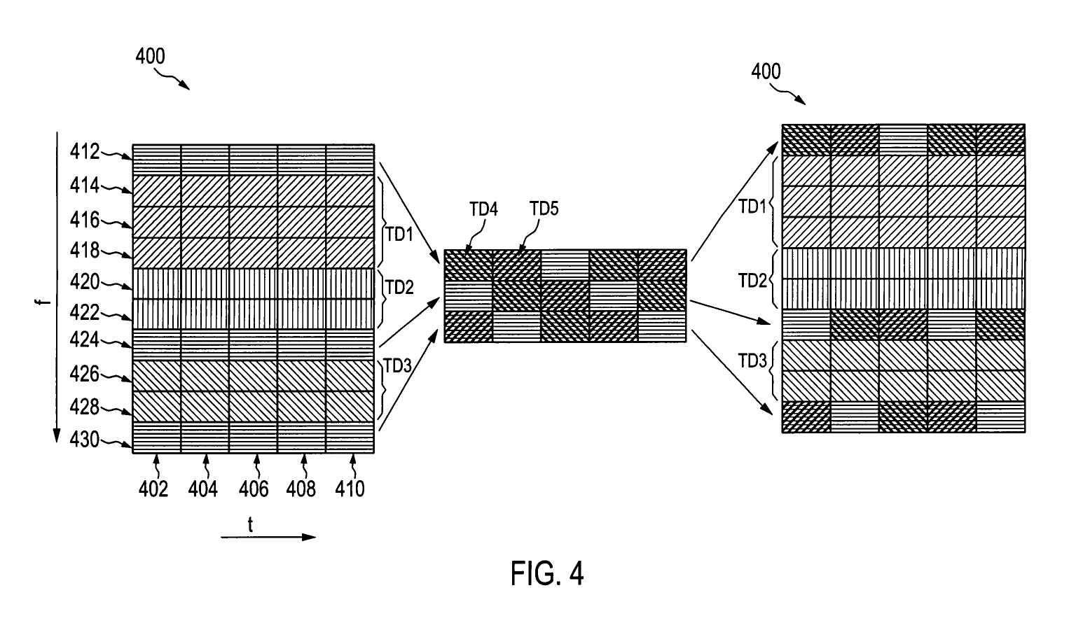

FIG. 4 shows a schematic diagram that represents the order of allocation, which is performed by an allocation-control device in accordance with the present invention. The resources comprised by a sub-frame 400 are to be allocated to a total of five terminal devices TD1 to TD5 in this exemplary diagram. Sub-frame 400 consists of five OFDM symbols 402 to 410, which are represented in the same manner as OFDM symbol 336 of FIG. 3.

The sub-carrier blocks of the OFDM sub-frame 400 are first subjected to localized allocation. The result of this firstallocating of these allocations is shown on the left-hand side of FIG. 4. Each terminal device is associated with a particular hatching type that is used for filling the rectangles that represent a particular sub-carrier block of an OFDM symbol. As can be seen, only terminal devices 1 to 3 receive localized allocation of sub-carrier blocks 414 to 418 (terminal device 1), 420 to 422 (terminal device 2) and 426 to 428 (terminal device 3). The remaining sub-carrier blocks 412, 424, and 430 are subject to distributed allocations for terminal devices 4 and 5. This distributed allocation of these frequency chunks for the time duration of the sub-frame 400 is performed in a second allocating and represented by the center section of FIG. 4.

As explained before, the distributed allocation follows a cyclic hopping pattern. Identical hatchings of respective sub-carrier blocks in respective OFDM symbols represent an allocation of the corresponding sub-carrier block to a respective terminal device. The resulting allocation of the resources represented by sub-frame 400 is shown on the right-hand side of FIG. 4. Note that in this FIG. a hatching with horizontal thin lines represents no allocation, that is, no data are sent in the corresponding sub-carrier block of the corresponding OFDM symbol.

The scheme explained above makes use of an assumption that a minimum sub-carrier block for localized and distributed allocations is the same. The present scheme allows the full band distribution without using puncturing or any difficult processing. Note that localized allocation is assumed to use the same sub-carrier blocks of all OFDM symbols in sub-frame. Therefore, no other signalling is required than that described heretofore.

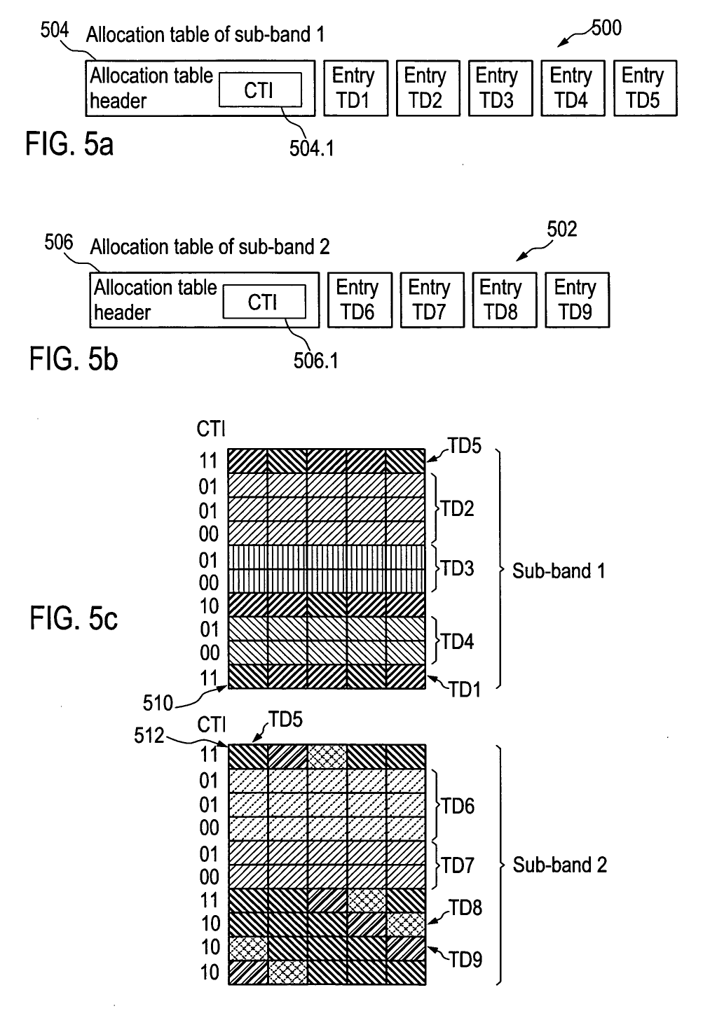

An embodiment using a sub-band structure of the transmission resources is explained in the following with reference to FIG. 5.

FIGS. 5a) and 5b) show two allocation tables 500 and 502 for a sub-band 1 and sub-band 2, respectively. Sub-band 1 and sub-band 2 together form the transmission resources in the present exemplary system. Of course, more sub-bands could be present without having to deviate from the scheme presented below.

As can be seen from the allocation tables 500 and 502 for sub-band 1 and sub-band 2, respectively, a total of nine terminal devices make use of the transmission resources of the two sub-bands. Terminal devices 1 to 5 use sub-band 1, and terminal devices 6 to 9 use sub-band 2.

Each allocation table 500 and 502 comprises an allocation table-header 504 and 506, respectively, each comprising a section 504.1, 506.1 with a chunk-type indicator sequence, which is formed by respective chunk-type indicator pairs as indicated in vertical column notation in FIG. 5c) for showing the association with a respective sub-carrier block.

In the present embodiment, the respective allocation table is mapped onto the first OFDM symbol of each sub-frame. Sub-band division and the location of the sub-band allocation table need to be signaled to indicate these positions.

Specifically, in the present example, the sub-band allocation tables starts from a respective first sub-carrier block shown at the top of each sub-band. For instance, the sub-bands can be identified using a respective sub-band ID, which in the present example are “1” or “2”.

The spectral position of the allocation table can be signaled using a sub-carrier block identifier (ID). The sub-band ID and the sub-carrier block ID are attached to each sub-band and each sub-carrier block, based on the given order in the frequency domain. Note that it may be specified in a standard that the physical mapping of the allocation table of each sub-band starts from the beginning of the sub-band in the first OFDM symbol. This way, the above signalling can be avoided.

Based on an implemented interference control scheme and/or a given TD capability, a sub-band or a set of sub-bands will be assigned semi-statically to each terminal device. Following this semi-static assignment, each terminal device will read the allocation tables of all sub-bands assigned to the particular terminal device. Note that more than one sub-band can be assigned to one terminal device.

In the present embodiment the meaning of the chunk-type indicators is unchanged in comparison with the earlier description. Therefore, the following description focuses on the particularities of the present example.

A continuation of an allocation in the frequency domain, which is indicated by the second bit of the chunk-type indicator pair is interpreted by the terminal devices with respect to the whole system bandwidth. In the present example, it will be appreciated that the allocation of terminal device 5 extends over those sub-bands 1 and 2, as can be seen by the hatching used for terminal device 5, which appears in both sub-bands. Correspondingly, the second bit of the chunk-type indicator pair for sub-carrier block 510 in FIG. 5c) means that for terminal device 5 the distributed allocation continues in the second sub-band 2 at sub-carrier block 512. The distributed allocation does not continue for terminal device 1, which is restricted to sub-band 1. In sub-band 2, terminal device 5 shares the resources of the allocated sub-carrier blocks with terminal devices 8 and 9. The above example applies for instance to a case where each sub-band has a width of 10 MHz, while TD5 has a capability of 20 MHz. As has been shown, the allocation of TD5 is cyclically distributed in sub-bands 1 and 2 separately.

Note that the allocation table of sub-band 2 in FIG. 5b) does not contain an entry for terminal device 5. Since there is an entry of UE5 in the sub-band 1, and the (last) indicator bits of sub-band 1 indicate that the allocation continues to the next frequency chunk, it is clear to the terminal device TD5 that the allocation continues to the next sub-frame. So it is not necessary to send the allocation entry again.

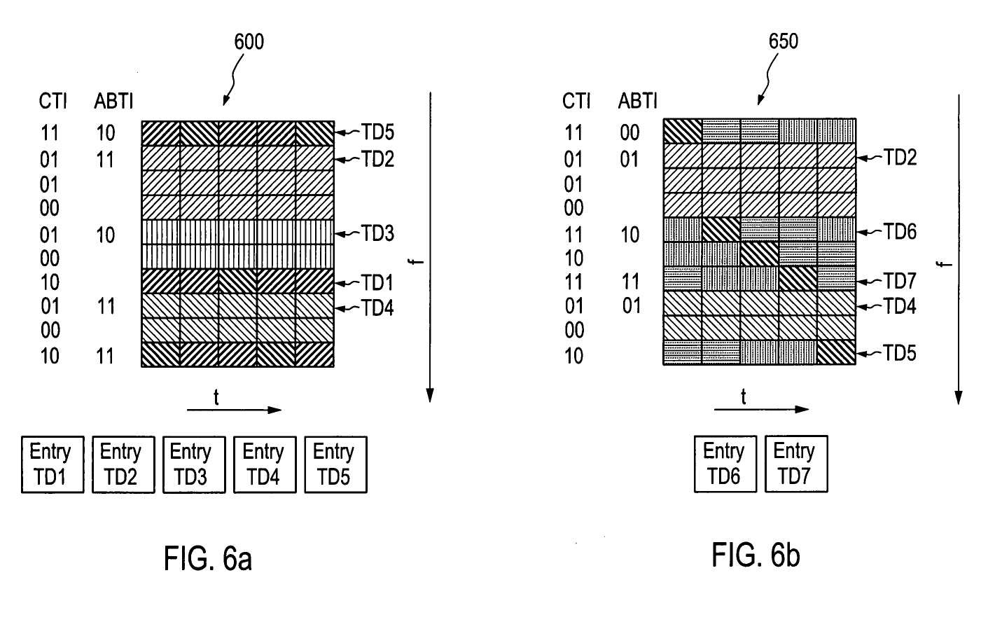

Reference is now made to FIG. 6 for explaining a further preferred embodiment of the invention, which introduces the use of an allocation, which lasts longer than one sub-frame.

This embodiment is particularly useful in a system that has a small bandwidth, such as 1.25 MHz or 2.5 MHz. According to this embodiment of the invention a dynamic control of the allocation length is provided, which helps avoiding a segmentation. This can be achieved by introducing allocation block type indicators.

Preferably, allocation-block-type indicator pairs are used, where two allocation block type indicator (ABTI) bits are used per allocation block. The first ABTI bit indicates whether or not an entry exists or not. Specifically, the bit value 0 of the first ABTI bit indicates that no entry exists in the present allocation table.

For a long allocation block, no entry is required, except for the first sub-frame. Also, if there is no data be sent, no entry is required. However, this needs to be communicated to the terminal devices. A bit value of 1 in the first ABTI bit indicates that an entry exists in the present allocation table.

The second bit of the ABTI pair is a continuation flag bit, indicating, whether the allocation continues to a next sub-frame or not. The bit value 0 indicates that the allocation does not continue to the next sub-frame. The bit value of 1 in the second ABTI bit indicates that the allocation does continue to the next sub-frame.

Therefore, the ABTI bits can be used as follows:
11: First sub-frame of a long allocation block
01: Middle-sub-frame of a long allocation block
00: Last-sub-frame of a long allocation block
10: Allocation block using only one sub-frame, i. e. no use of a long allocation block.

Note that the first bit of the ABTI pair can also be used for the blank resource blocks, which are not allocated to any terminal devices. Only the first ABTI bit is required, if the long allocation block concept is used only for localized allocations. An entry of a long allocation block exists only in the first sub-frame, with which the long allocation block starts. No entry of ABTI bit pairs is made in following sub-frames. This applies to both distributed and localized allocations. The order between ABTI entries and allocation blocks must match that of the CTI bits. Since the first bit of the ABTI indicates whether an entry exists for a corresponding allocation block or not, the required order-matching is maintained. The second ABTI bit indicates, to which sub-frame the allocation continues.

A long allocation block, that is subjected to an allocation of the localized type, uses the same sub-carrier blocks of the following sub-frames. For a distributed-type allocation, a terminal device knows, which distributed allocations continue to the next sub-frame by using the first bit of the chunk-type indicator pair, which indicates whether the allocation is distributed or localized, and the second bit of the ABTI pair. The terminal device thus knows that it uses the d-th distributed allocation block for this sub-frame, which continues to the next sub-frame. Then, the terminal device will use the d-th distributed allocation block of the next sub-frame. This process is continued for sub-frame while the allocation continues. In the example of FIG. 6, TD5 uses the first distributed allocation that continues to the next sub-frame. Therefore, TD5 uses the first distributed allocation block also in the next sub-frame, which is shown on the right-hand side of FIG. 6. In the next sub-frame, TD6 and 7 and will know their entries by looking up the first bit of the ABTI pair in this sub-frame and skipping other allocation blocks.

Note that the size of an allocation block can be changed on a sub-frame-by-sub-frame basis if necessary, for both localized and distributed allocation types.

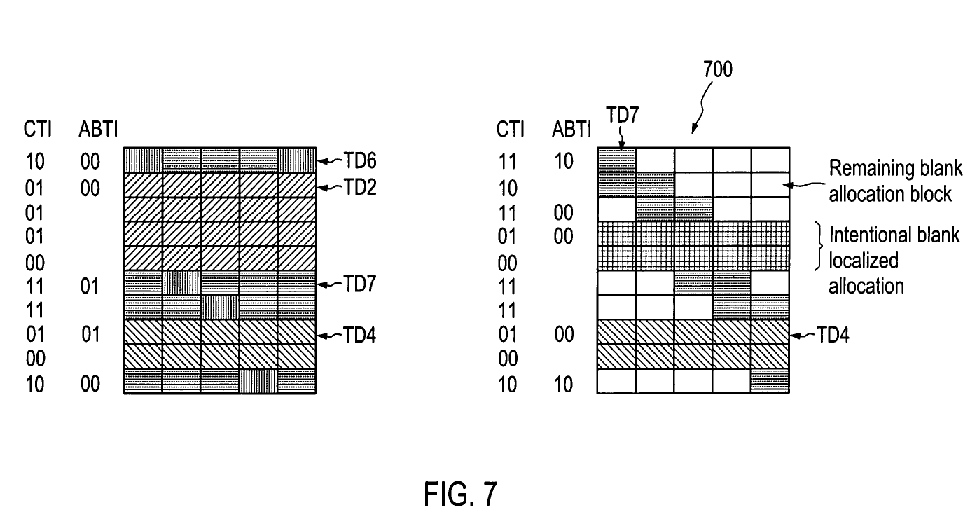

Resource blocks, which are not allocated to any terminal device and do not contain any data to transmit, should also have their corresponding entries in the allocation table. If there is no data to put, a blank allocation block is indicated by the first bit of an ABTI pair. By inserting blank localized allocation intentionally, it is also possible to increase the frequency diversity of the localized allocation of terminal device 7, as can be seen in FIG. 7 in a sub-frame 700 on the right-hand side. These resource blocks can be used either for sending additional pilots or just for turning off the transmission to reduce the interference. These choices can be indicated by using pre-determined and reserved identifiers, which is placed in the TD identifier field of the entry. For example,
(a) “TD identifier=ID 0” means that neither data nor pilot is transmitted in the corresponding resource block. No transmission in this resource block.
(b) “TD identifier=ID 1,” means that the pilot with pattern 1 is transmitted in the corresponding resource block.
(c) “TD identifier=ID 2” means that the pilot with pattern 2 is transmitted in the corresponding resource block.
(d) The number of patterns for pilot can be determined in the specification.

Note that in the uplink case, if the resource is not allocated to any TDs, only “ID 0” can have the meaning.

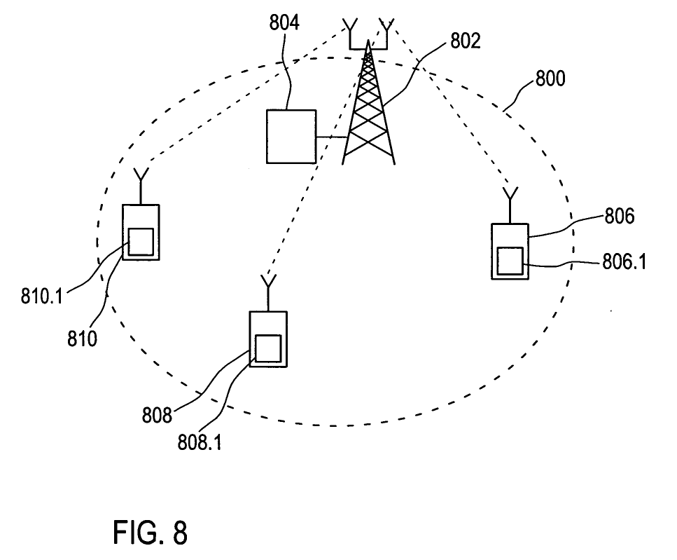

FIG. 8 shows a schematic diagram of a network cell of a radio access network. The network cell 800 contains a node B 802, which is connected with an allocation control device 804. Terminal devices 806, 808, and 810 are located in network cell 800 and communicate with node B 802 for exchanging user data and control signals. Each terminal device comprises a control unit 806.1, 808.1, and 810.1, respectively. The allocation-control device 804 controls operation of the node B 802 in the allocation of the multi-carrier transmission resources, for instance according to a OFDMA system. It allocates to a respective terminal device one or more sub-frames and at least one sub-carrier block in the frequency domain according to one of the embodiments described above. The control units of the terminal devices 806 to 810 detect the corresponding allocations and control the operation of the terminal device to use the allocated resources in uplink or downlink communication with node B 802. The previous description shows that the invention achieves a coexistence of localized and distributed allocations in one sub-frame of an OFDM transmission. Localized allocations can be scheduled flexibly a dynamically, without using a static or semi-static separation of resources into localized and distributed allocations. As has been shown, the distributed allocations exploit the frequency diversity of the complete bandwidth. The corresponding control signalling is reduced to a minimum amount by using the proposed structure of the allocation tables, in particular by using chunk-type indicator bit pairs. This enables each terminal device to easily detect its resource allocation without checking the control signalling to other terminal devices. Note that even though the previous specification focuses on the context of E-UTRA, the invention can be also applied to other future radio systems having requirements similar to E-UTRA.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising allocating to a respective terminal device of terminal devices in a network cell of a radio access network, the transmission resources being dividable into symbol-duration time spans in a time domain and into a plurality of sub-carriers in a frequency domain,
a group of consecutive symbol-duration time spans in the time domain and at least one respective sub-carrier block in the frequency domain, the at least one respective sub-carrier block being formed by a group of respective consecutive sub-carriers,
wherein the allocating comprises allocating a respective sub-carrier block and the group of symbol-duration time spans according to one respective allocation type, which is either a localized or a distributed allocation type, the localized allocation type allocating a respective sub-carrier block and the group of symbol-duration time spans to one respective terminal device, and the distributed allocation type allocating a respective sub-carrier block and the group of symbol-duration time spans to a respective set of terminal devices.

2. The method of claim 1, further comprising generating a control signal and transmitting a control signal to the terminals in the network cell using a common control channel, the control signal including an allocation table containing an allocation-table header and a plurality of allocation-table entries.

3. The method of claim 2, wherein generating the control signal comprises including a plurality of first sub-carrier-block type indicators in the allocation-table header, each first sub-carrier-block type indicator indicating whether an allocation of a respective sub-carrier block is a localized allocation or a distributed allocation to a respective terminal device.

4. The method of claim 2, wherein generating the control signal comprises including a plurality of second sub-carrier-block type indicators in the allocation-table header, each second sub-carrier-block type indicator indicating whether an allocation with the same allocation type, localized or distributed, of a respective next sub-carrier block is to the same terminal device or not.

5. The method of claim 2, wherein generating the control signal comprises including a plurality of sub-carrier-block type indicator pairs in the allocation-table header, each sub-carrier-block type indicator pair being formed by a first and a second sub-carrier-block type indicator, the first sub-carrier-block type indicator of a respective sub-carrier-block type indicator pair indicating whether an allocation of a respective sub-carrier block is a localized allocation or a distributed allocation to a respective terminal device, the second sub-carrier-block type indicator of a respective sub-carrier-block type indicator pair indicating whether an allocation having the same allocation type, localized or distributed, of a respective next sub-carrier block is to the same terminal device or not.

6. The method of claim 1, wherein the multi-carrier transmission resources are provided in accordance with an orthogonal frequency-division multiple access system.

7. The method of claim 1, wherein the group of symbol-duration time spans equals the duration of a sub-frame.

8. The method of claim 7, wherein generating and transmitting an allocation table is performed for each sub-frame.

9. The method of claim 8, comprising mapping a respective allocation table onto a first symbol of a respective sub-frame, and transmitting the allocation table with the first symbol of the sub-frame.

10. The method of claim 1, wherein a sub-carrier block comprises between 20 and 40 sub-carriers.

11. The method of claim 1, wherein the transmission resources cover a frequency spectrum of up to 20 MHz width in the frequency domain.

12. The method of claim 1, wherein the allocating comprises a first allocating, in which at least one allocation of the localized-allocation type is performed, and a second allocating, in which at least two allocations of the distributed-allocation type are performed.

13. The method of claim 2, wherein the number of allocation-table entries corresponds to the number of active terminal devices in the network cell.

14. The method of claim 2, wherein generating a control signal comprises including a respective terminal-device identifier in each allocation-table entry, and ordering the allocation-table entries in accordance with an order of resource blocks in the frequency domain.

15. The method of claim 5, wherein generating a control signal comprises including the sub-carrier-block type indicator pairs in the allocation-table header in an order that is in accordance with an order of resource blocks in the frequency domain.

16. The method of claim 1, wherein the allocating, in case of a distributed-allocation type, includes cyclically allocating a sub-carrier block in consecutive symbol-duration time spans to the set of terminal devices.

17. The method of claim 1, wherein the allocating, in case of a distributed-allocation type, includes allocating a plurality of resource blocks, and wherein distributed allocation to the set of terminal devices is performed cyclically over the plurality of resource blocks and the group of consecutive spans in the cyclic allocation.

18. The method of claim 1, wherein the transmission resources are partitioned into sub-bands in the frequency domain, and wherein the allocating is performed for each sub-band separately.

19. The method of claim 18, further comprising generating a control signal and transmitting a control signal to the terminals in the network cell using a common control channel, the control signal including an allocation-table containing an allocation-table header and a plurality of allocation-table entries, wherein generating and transmitting the control signal are performed on each sub-band separately.

20. The method of claim 18, further comprising generating a control signal and transmitting a control signal to the terminals in the network cell using a common control channel, the control signal including an allocation-table containing an allocation-table header and a plurality of allocation-table entries, wherein generating the control signal comprises including a plurality of second sub-carrier-block type indicators in the allocation-table header, each second sub-carrier-block type indicator indicating whether an allocation with the same allocation type, localized or distributed, of a respective next sub-carrier block is to the same terminal device or not, wherein a second sub-carrier-block type indicator, which is associated with a last sub-carrier block of a first sub-band, is used to indicate whether an allocation having the same allocation type, localized or distributed, of a respective first sub-carrier block of a neighboring second sub-band is to the same terminal device or not.

21. The method of claim 18, wherein, in case an allocation of the distributed allocation type is made, the allocating is restricted to a respective sub-band and includes allocating the at least one sub-carrier block within the group of symbol-duration time spans in a cyclic manner to a number of terminal devices.

22. The method of claim 1, wherein transmitting the control signal comprises appending in the control signal the allocation-table header to that allocation-table entry of the allocation table, which is transmitted first.

23. The method of claim 1, wherein the group of symbol-duration time spans in the time domain and the at least one respective sub-carrier block in the frequency domain form an allocation block, and wherein the allocating comprises allocating a long allocation block being formed by a plurality of successive allocation blocks according to an either localized or distributed allocation type.

24. The method of claim 23, further comprising including into the allocation-table header a plurality of first allocation-block type indicators indicating whether or not a respective current allocation block is a first allocation block of a long allocation block.

25. The method of claim 23, further comprising including into the allocation-table header a plurality of second allocation-block type indicators indicating whether or not a respective long allocation block continues in a respective subsequent allocation block.

26. The method of claim 23, further comprising including into the allocation-table header a plurality of allocation-block type indicator pairs, each allocation-block type indicator pair comprising a first allocation-block type indicator indicating whether or not a respective current allocation block is a first allocation block of a long allocation block, and each second allocation-block type indicator indicating whether or not a respective long allocation block continues in a respective subsequent allocation block.

27. The method of claim 23, wherein the allocating comprises dynamically changing the number of resource blocks of consecutive allocation blocks in a long allocation block.

28. An allocation-control device comprising a control unit configured to allocate to a respective terminal device of terminal devices in a network cell of a radio access network, with transmission resources being dividable into symbol duration intervals in a time domain and into a plurality of sub-carriers in a frequency domain, a group of consecutive symbol-duration time spans in the time domain and at least one respective sub-carrier block in the frequency domain, the at least one respective sub-carrier block being formed by a group of respective consecutive sub-carriers, and
to allocate a respective sub-carrier block and the group of consecutive symbol-duration time spans according to one respective allocation type, which is either a localized or a distributed allocation type, the localized allocation type allocating the respective sub-carrier-block and the group of consecutive symbol-duration time spans to one respective terminal device, and the distributed allocation type allocating the respective carrier-block and the group of consecutive symbol-duration time spans to a respective set of terminal devices.

29. The allocation-control device of claim 28, wherein the control unit is further configured to generate an allocation table containing an allocation-table header and a plurality of allocation-table entries.

30. The allocation-control device of claim 29, wherein the control unit is further configured to include in the allocation-table header a plurality of first sub-carrier-block type indicators, each indicating whether an allocation of a respective sub-carrier block to a respective terminal device is of the localized-allocation type or of the distributed-allocation type.

31. The allocation-control device of claim 29, wherein the control unit is further configured to include in the allocation-table header a plurality of second sub-carrier-block type indicators, each second sub-carrier-block type indicator indicating whether an allocation with the same allocation type, localized or distributed, of a respective next sub-carrier block is to the same terminal device or not.

32. The allocation-control device of claim 29, wherein the control unit is further configured to include in the allocation-table header a plurality of sub-carrier-block type indicator pairs in the allocation-table header, each sub-carrier-block type indicator pair being formed by a first and a second sub-carrier-block type indicator, the first sub-carrier-block type indicator of a respective sub-carrier-block type indicator pair indicating whether an allocation of a respective sub-carrier block is a localized allocation or a distributed allocation to a respective terminal device, the second sub-carrier-block type indicator of a respective sub-carrier-block type indicator pair indicating whether an allocation having the same allocation type, localized or distributed, of a respective next sub-carrier block is to the same terminal device or not.

33. The allocation-control device of claim 29, wherein the control unit is further configured to generate a respective allocation table in connection with each group of consecutive symbol-duration time spans.

34. The allocation-control device of claim 29, wherein the control unit is configured to map a respective allocation table onto a first symbol of a respective sub-frame.

35. The allocation-control device of claim 29, wherein the control unit is configured to include a as many allocation-table entries in the allocation table as there are active terminal devices in the network cell.

36. The allocation-control device of claim 29, wherein the control unit is configured to include a respective terminal-device identifier in each allocation-table entry, and to set an order of the allocation-table entries in accordance with an order of resource blocks in the frequency domain.

37. The allocation-control device of claim 32, wherein the control unit is configured to include the sub-carrier-block type indicator pairs in the allocation-table header in an order that is in accordance with an order of resource blocks in the frequency domain.

38. The allocation-control device of claim 28, wherein the control unit is configured to cyclically allocate a sub-carrier block in consecutive symbol-duration time spans to the set of terminal devices in case of a distributed-allocation type.

39. The allocation-control device of claim 28, wherein the control unit is configured to allocate a plurality of resource blocks, and to perform a distributed allocation to the set of terminal devices cyclically over the plurality of resource blocks and the group of consecutive spans.

40. The allocation-control device of claim 28, wherein the control unit is configured to allocate a respective sub-carrier block and the group of consecutive symbol-duration time spans for each of a plurality of sub-bands in the frequency domain separately.

41. The allocation-control device of claim 28, wherein the control unit is further configured to allocate a long allocation block being formed by a plurality of successive allocation blocks according to an either localized or distributed allocation type, an allocation block being formed by the group of symbol-duration time spans in the time domain and the at least one respective sub-carrier block in the frequency domain.

42. The allocation-control device of claim 41, wherein the control unit is further configured to generate and include into the allocation-table header a plurality of first allocation-block type indicators indicating whether or not a respective current allocation block is a first allocation block of a long allocation block.

43. The allocation-control device of claim 41, wherein the control unit is further configured to generate and include into the allocation-table header a plurality of second allocation-block type indicators indicating whether or not a respective long allocation block continues in a respective sub-sequent allocation block.

44. The allocation-control device of claim 41, wherein the control unit is further configured to generate and include into the allocation-table header a plurality of allocation-block type indicator pairs, each allocation-block type indicator pair comprising a first allocation-block type indicator indicating whether or not a respective current allocation block is a first allocation block of a long allocation block, and each second allocation-block type indicator indicating whether or not a respective long allocation block continues in a respective subsequent allocation block.

45. The allocation-control device of claim 41, wherein the control unit is further configured to dynamically change the number of resource blocks of consecutive allocation blocks in a long allocation block.

46. The allocation-control device of claim 28, wherein the control unit is configured as an add-on module to a network node of a radio access network.

47. A network node of a radio-access network, comprising an allocation-control device according claim 28.

48. A network cell of a radio-access network, comprising at least one network node of claim 47.

49. A radio access network, comprising at least one network cell according to claim 48.

50. A control signal for localized or distributed allocation of multi-carrier transmission resources, comprise a plurality of sub-carriers, to terminal devices in a network cell of a radio access network, the control signal encoding an allocation table containing an allocation-table header and a plurality of allocation-table entries, wherein the allocation-table header contains
either a plurality of first sub-carrier-block type indicators, each indicating whether an allocation of a respective resource block, which consists of a group of respective sub-carriers, is a localized allocation or a distributed allocation to a respective terminal device,
or a plurality of second sub-carrier-block type indicators, each indicating whether an allocation having the same allocation type, localized or distributed, of a respective next sub-carrier block is to the same terminal device or not,
or a plurality of sub-carrier-block type indicator pairs, each being formed by a first and a second sub-carrier-block type indicator, the first sub-carrier-block type indicator of a respective sub-carrier-block type indicator pair indicating whether an allocation of a respective sub-carrier block is a localized allocation or a distributed allocation to a respective terminal device, the second sub-carrier-block type indicator of a respective sub-carrier-block type indicator pair indicating whether an allocation having the same allocation type, localized or distributed, of a respective next sub-carrier block is to the same terminal device or not.

51. The control signal of claim 50, wherein the control signal comprises the allocation-table header appended to that allocation-table entry, which is transmitted first in the control signal.

52. The control signal of claim 50, wherein the allocation-table entry, which is transmitted first, comprises a self-decodable channel coding block with error detection.

53. The control signal of claim 50, wherein each allocation-table entry comprises a terminal-device identifier, and wherein the order of the allocation-table entries corresponds to an order of resource blocks in the frequency domain.

54. The control signal of claim 50, wherein an allocation table for a respective sub-frame is mapped onto the first symbol of the sub-frame.

55. The control signal of claim 50, further comprising a sub-band identifier.

56. The control signal of claim 55, further comprising a first-sub-carrier-block identifier for indicating a frequency of a first sub-carrier of a first sub-carrier block in a sub-band.

57. A control unit for a terminal device to be operated in a network cell of a radio access network, the control-unit comprising an allocation-table evaluation unit, which is configured to decode a received control signal for localized or distributed allocation of multi-carrier transmission resources, which comprise a plurality of sub-carriers, to terminal devices in a network cell of the radio access network, and to decode from the control signal an allocation table containing an allocation-table header, wherein the allocation-table header contains
either a plurality of first sub-carrier-block type indicators, each indicating whether an allocation of a respective resource block, which consists of a group of respective sub-carriers, is a localized allocation or a distributed allocation to a respective terminal device,
or a plurality of second sub-carrier-block type indicators, each indicating whether an allocation having the same allocation type, localized or distributed, of a respective next sub-carrier block is to the same terminal device or not,
or a plurality of sub-carrier-block type indicator pairs, each being formed by a first and a second sub-carrier-block type indicator, the first sub-carrier-block type indicator of a respective sub-carrier-block type indicator pair indicating whether an allocation of a respective sub-carrier block is a localized allocation or a distributed allocation to a respective terminal device, the second sub-carrier-block type indicator of a respective sub-carrier-block type indicator pair indicating whether an allocation having the same allocation type, localized or distributed, of a respective next sub-carrier block is to the same terminal device or not, and to evaluate the allocation-table header to locate and decode an allocation-table entry, which is associated with the terminal device.

58. An allocation-control device comprising
means for allocating to a respective terminal device of terminal devices in a network cell of a radio access network, with transmission resources being dividable into symbol duration intervals in a time domain and into a plurality of sub-carriers in a frequency domain, a group of consecutive symbol-duration time spans in the time domain and at least one respective sub-carrier block in the frequency domain, the at least one respective sub-carrier block being formed by a group of respective consecutive sub-carriers, and
means for allocating a respective sub-carrier block and the group of consecutive symbol-duration time spans according to one respective allocation type, which is either a localized or a distributed allocation type, the localized allocation type allocating the respective sub-carrier-block and the group of consecutive symbol-duration time spans to one respective terminal device, and the distributed allocation type allocating the respective sub-carrier-block and the group of consecutive symbol-duration time spans to a respective set of terminal devices.
